(19) United States
(12) Patent Application Publication
(10) Pub. No.: US 2026/0075364 A1
(43) Pub. Date: Mar. 12, 2026

(54) TWS BLUETOOTH HEARING AIDS

(71) Applicant: OXTI Pte Ltd, Singapore (SG)

(72) Inventor: Chih-Feng Ho, Singapore (SG)

(21) Appl. No.: 18/830,606

(22) Filed: Sep. 11, 2024

(51) Int. Cl. H04R 5/033; H04R 25/00

(52) U.S. Cl. CPC H04R 5/033; H04R 25/554; H04R 25/65

(57) ABSTRACT

A TWS Bluetooth hearing aid includes a housing. Connecting slots are formed in an upper part of the housing at two sides thereof. Each connecting slot has an inlet, in which an earphone is receivable such that a bottom end of the earphone contacts a charging connection mechanism. A clamping mechanism is arranged on one side of an external wall of the housing, and a hearing microphone is arranged on an opposite side of the external wall. The hearing microphone is connectable to the earphone via Bluetooth. The housing is selectively fixed to a wearer's collar through the clamping mechanism, and external speech is receivable by the hearing microphone arranged on the housing to convert into information that is then transmitted via Bluetooth to the earphone to be played back so as to make it easier for the wearer to hear the speech clearly.

### BACKGROUND OF THE INVENTION

(a) Technical Field of the Invention

The present invention relates to the technical field of Bluetooth hearing aids, and more particularly to a TWS Bluetooth hearing aid.
(b) Description of the Prior Art

TWS stands for True Wireless Stereo. The TWS technology is based on the development of Bluetooth chip technology. Hearing aids, also known as personal amplifiers, aim to amplify environmental sounds. Users do not intend to compensate for hearing loss and therefore do not require professional tuning. Personal hearing aids are suitable for watching TV, attending lectures, conversing with family and friends, and so on. They are not used for diagnosing, treating, curing, or alleviating diseases, nor do they alter the structure or function of the human body. They are not medical devices.

Existing TWS Bluetooth hearing aids have the following drawbacks. They are designed as integrated structures for both ears, requiring both earphones to be worn simultaneously. They are also relatively bulky, making them inconvenient to carry.

### SUMMARY OF THE INVENTION

An objective of the present invention is to provide a TWS Bluetooth hearing aid, which achieves fixation of the housing on a wearer's collar through a set of clamping mechanism so as to allow external speech to be received by a hearing aid microphone arranged on the housing to be converted into information. The information is then transmitted via Bluetooth to and played back on an earphone so as to facilitate the wearer's ability to hear speech clearly. This solves the problem of existing TWS Bluetooth hearing aids, which are designed with an integrated dual-ear structure, requiring use on both ears simultaneously. Additionally, the existing devices are relatively bulky, making them inconvenient to carry.

A TWS Bluetooth hearing aid according to an embodiment of the present invention comprises a housing. An upper side of the housing is formed with connecting slots on two sides thereof. An inlet is formed in a bottom wall of each of the connecting slots so that an earphone is receivable into and thus installed in the inlet to allow a bottom end of the earphone to rest against a charging wiring mechanism inside the housing. One side of an outer wall of the housing is equipped with a clamping mechanism, while an opposite side of the outer wall is equipped with a hearing aid microphone. The hearing aid microphone is connectable to the earphone via Bluetooth.

Further, a charging port is provided on a bottom wall of the housing, and the charging port is connected to the charging connection mechanism inside the housing.

Further, the clamping mechanism includes a buckle ring fixed to a side wall of the housing, and a rotating rod rotatably mounted within the buckle ring.

Further, a lower part of the rotating rod is connected to a pressing plate, which has a lower part contacting the side wall of the housing, and the lower part of the pressing plate is curved towards the housing.

Further, a torsion spring is arranged on a middle part of the rotating rod. Two ends of the torsion spring are fixed to the buckle ring and the pressing plate, respectively. When the pressing plate is acted on by an external force to rotate outward, the torsion spring acts on the buckle ring, and when the external force is removed, the torsion spring returns pushes the pressing plate to move towards the side wall of the housing.

Further, the charging wiring mechanism includes a fixed column set on a bottom wall inside the inlet, a telescopic groove formed in a middle of a top end of the fixed column, and a spring provided on a bottom wall of the telescopic groove.

Further, a telescopic column is arranged partly inside the spring. A baffle is arranged on an outer wall of a lower part of the telescopic column, and a lower part of the baffle is connected to the spring.

Further, an upper part of the telescopic column extends through an opening of the fixed column in communication with the telescopic groove and has a contact point at a distal end and contactable with an electrode piece on a bottom end of the earphone to achieve electrical energy transfer.

Further, a magnetic attraction piece is provided on a bottom wall of the connecting slot at one side thereof. The magnetic attraction piece attracts a magnetic piece on a lower part of the earphone so as to fix the earphone in the connecting slot through magnetic attraction.

Further, an adjustment plug is provided on a sound outlet of the earphone, and the adjustment plug is adapted to fit an ear canal of a user.

Compared to the prior art, the beneficial effects of the present invention are as follows:

The clamping mechanism secures the housing on the wearer's collar, allowing external speech to be received by the hearing aid microphone arranged on the housing and converted into information. The information is then transmitted via Bluetooth and played back on the earphone, facilitating clear hearing for the wearer. Additionally, the two earphones can be worn independently, ensuring usability and improving the comfort of wearing the earphones.

When the earphones are fixed in the housing, the magnetic attraction piece and the magnetic piece secure the earphones within the connecting slots. The electrode pieces at the bottoms of the earphones connect with the contact points, allowing external electrical energy to be transferred from the charging port to charge the earphones. The spring ensures that the earphones maintain contact with the contact points, enhancing the charging effectiveness.

### BRIEF DESCRIPTION OF THE DRAWINGS

The drawings are provided to offer a further understanding of the present invention and form part of the specification. They are used to explain the present invention along with the embodiments and do not constitute a limitation of the present invention. In the drawings:

FIG. 1 is a schematic view showing a rear-side structure of a true wireless stereo (TWS) Bluetooth hearing aid according to the present invention;

FIG. 2 is a cross-sectional view showing the TWS Bluetooth hearing aid according to the present invention;

FIG. 3 is an enlarged view of an encircled region “A” of FIG. 2; and

FIG. 4 is a top view showing the TWS Bluetooth hearing aid according to the present invention.

### DETAILED DESCRIPTION OF THE PREFERRED EMBODIMENTS

To provide a clearer understanding of the objectives, technical solutions, and advantages of the present invention, the following detailed description, along with the accompanying drawings and embodiments, will be presented. It should be understood that the specific embodiments described here are intended to explain the present invention and are not meant to limit the present invention.

The detailed description of the implementation of the present invention will be provided in conjunction with specific embodiments.

In the drawings, the same or similar reference numbers correspond to the same or similar components. In the description of the present invention, it should be understood that terms such as “upper,” “lower,” “left,” “right,” and the likes, are used to describe positions or orientations based on the views shown in the drawings. These terms are for the convenience of describing the present invention and simplifying the description, and are not meant to indicate or imply that a device or a component must have a specific orientation, construction, or operation. Thus, the positional terminology used in the drawings is only for explanation and should not be construed as a limitation to the invention. For those skilled in the art, the specific meanings of these terms can be understood according to the context.

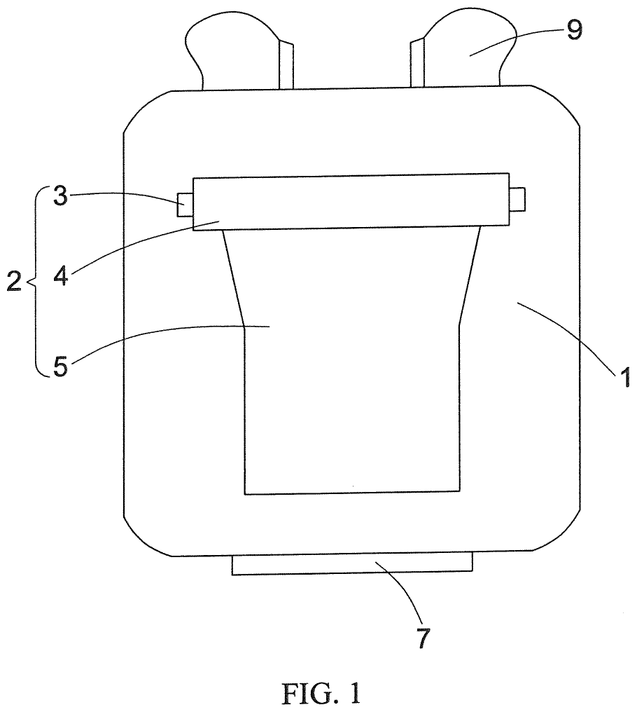

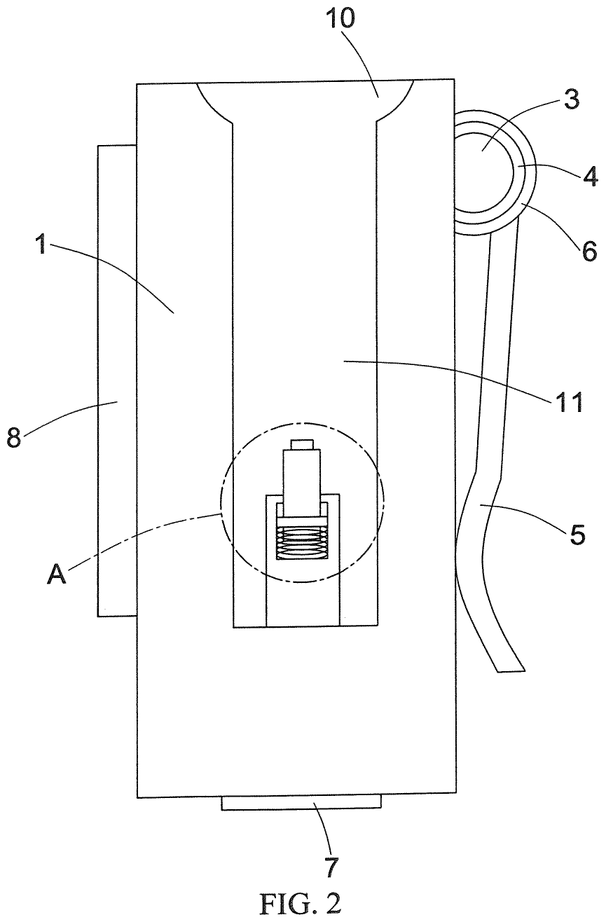

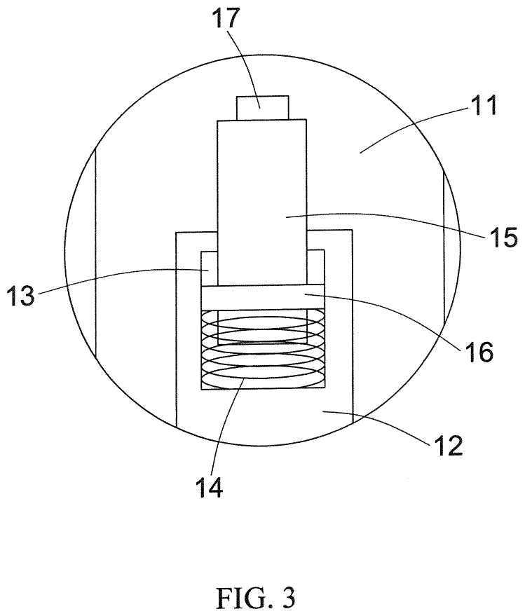

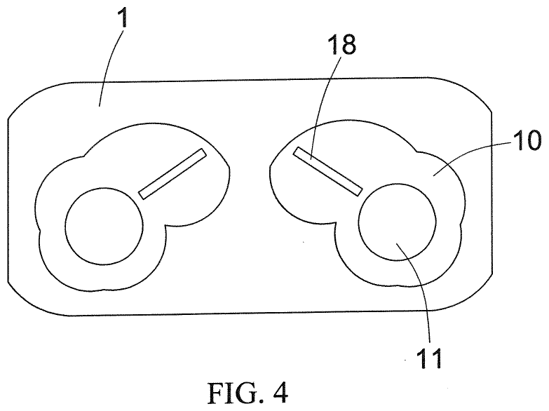

Referring to FIGS. 1-4, a true wireless stereo (TWS) Bluetooth hearing aid according to a preferred embodiment of the present invention is provided.

The TWS Bluetooth hearing aid includes a housing (1). An upper part of the housing (1) is formed with two connecting slots (10) on two sides thereof. An inlet (11) is provided on a bottom wall of each of the connecting slots (10) to receive an earphone (9) to install therein, such that a bottom end of the earphone (9) rests against a charging wiring mechanism arranged inside the housing (1). One side of an outer wall of the housing (1) is equipped with a clamping mechanism (2), while the other side is provided with a hearing aid microphone (8). The hearing aid microphone (8) is connectable to the earphone (9) via Bluetooth. External speech is received by the hearing aid microphone (8) arranged on the housing (1) and converted into information, which is then transmitted via Bluetooth and played back on the earphone (9), facilitating clear hearing for a wearer.

In the embodiment, a charging port (7) is provided on a bottom wall of the housing (1) and is connected to the charging wiring mechanism inside the housing (1), so that external electrical energy can be transferred to charge the earphone (9).

In the embodiment, the clamping mechanism (2) includes a buckle ring (4) fixed on the side wall of the housing (1). A rotating rod (3) is rotatably fitted within the buckle ring (4). A lower part of the rotating rod (3) is connected to a pressing plate (5). One side of a lower part of the pressing plate (5) presses against the side wall of the housing (1), and the lower part of the pressing plate (5) is curved towards the housing (1). A torsion spring (6) is arranged around a middle part of the rotating rod (3) and has two ends fixed to the buckle ring (4) and the pressing plate (5), respectively. When the pressing plate (5) is rotated outward away from the housing (1) by an external force, the torsion spring (6) acts on the buckle ring (4). When the external force is removed, the torsion spring (6) returns and pushes the pressing plate (5) to move towards the side wall of the housing (1). The clamping mechanism (2) ensures that the housing (1) is securely fixed on a user's collar, allowing the hearing aid microphone (8) arranged on the housing (1) to receive and convert external speech.

In the embodiment, the charging wiring mechanism includes a fixed column (12) on a bottom wall inside the inlet (11). A top end of the fixed column (12) is formed, in a middle part thereof, with a telescopic groove (13), and a spring (14) is placed on a bottom wall of the telescopic groove (13). A telescopic column (15) is partly installed inside the spring (14) and a baffle (16) is arranged on an outer wall of a lower part of the telescopic column (15). The baffle (16) is connected to the spring (14) arranged on and connected to a lower part thereof. An upper part of the telescopic column (15) extends through an opening of the fixed column in communication with the telescopic groove (13) and has a contact point (17) at a distal end. An electrode piece is arranged on the bottom end of the earphone (9) and is contactable and connectable with the contact point (17) to allow external electrical energy to be transferred from the charging port (7) to charge the earphone (9).

In the embodiment, a magnetic attraction piece (18) is provided on the bottom wall on one side of the connecting slot (10). The magnetic attraction piece (18) attracts a magnetic piece on a lower part of the earphone (9) in order to secure the earphone (9) in the connecting slot (10) through magnetic attraction.

In the embodiment, an adjustment plug is provided on a sound outlet of the earphone (9) and is adapted to fit the ear canal, making it easier for people with different ear canal diameters to wear the earphone and ensuring a secure fit.

In use, the clamping mechanism (2) first fixes the housing (1) on the user's collar, and external speech is received by the hearing aid microphone (8) on the housing (1) to be converted into information, which is transmitted via Bluetooth and played back on the earphones (9) to facilitate clear hearing for the user. Additionally, the earphones (9) can be worn independently, ensuring usability and improving comfort. When charging, the earphones (9) are fixed within the housing (1). Magnetic attraction between the magnetic attraction piece (18) and the magnetic piece of the earphone secures the earphone (9) in the connecting slot (10), and the electrode piece at the bottom of the earphone (9) connects with the contact point (17), allowing external electrical energy to be transferred from the charging port (7) to charge the earphone (9). The spring (14) ensures that the earphone (9) maintains contact with the contact point (17), enhancing the charging effectiveness.

In the embodiment, the entire operation process can be controlled by a computer, with automation control achieved through a programmable logic controller (PLC) and other technologies. Sensors can be used in various operational stages for signal feedback and to ensure sequential execution of steps. These are conventional knowledge in automation control and are not elaborated further in the embodiment.

Any aspects of the present invention not detailed here are known techniques to those skilled in the art.

Although the embodiments of the present invention have been shown and described, those skilled in the art will understand that various modifications, changes, substitutions, and variations of these embodiments can be made without departing from the principles and spirit of the present invention. The scope of the present invention is defined by the appended claims and their equivalents.

I claim:

1. A true wireless stereo (TWS) Bluetooth hearing aid, comprising a housing, connecting slots being formed in an upper part of the housing on two sides thereof, each of the connecting slots comprising an inlet, in which an earphone is receivable, such that a bottom end of the earphone contacts a charging connection mechanism arranged in the housing, a clamping mechanism being arranged on one side of an external wall of the housing, a hearing microphone being arranged on an other side of the external wall of the housing, the hearing microphone being connectable to the earphone via Bluetooth.

2. The TWS Bluetooth hearing aid according to claim 1, wherein a charging port is provided on a bottom wall of the housing, and the charging port is connected to the charging connection mechanism inside the housing.

3. The TWS Bluetooth hearing aid according to claim 1, wherein the clamping mechanism includes a buckle ring fixed to a side wall of the housing, and a rotating rod rotatably mounted within the buckle ring.

4. The TWS Bluetooth hearing aid according to claim 3, wherein a lower part of the rotating rod is connected to a pressing plate, which has a lower part contacting the side wall of the housing, and the lower part of the pressing plate is curved towards the housing.

5. The TWS Bluetooth hearing aid according to claim 4, wherein a torsion spring is arranged on a middle part of the rotating rod, two ends of the torsion spring being respectively fixed to the buckle ring and the pressing plate, wherein when the pressing plate is acted on by an external force to rotate outward, the torsion spring acts on the buckle ring, and when the external force is removed, the torsion spring returns pushes the pressing plate to move towards the side wall of the housing.

6. The TWS Bluetooth hearing aid according to claim 2, wherein the clamping mechanism includes a buckle ring fixed to a side wall of the housing, and a rotating rod rotatably mounted within the buckle ring.

7. The TWS Bluetooth hearing aid according to claim 6, wherein a lower part of the rotating rod is connected to a pressing plate, which has a lower part contacting the side wall of the housing, and the lower part of the pressing plate is curved towards the housing.

8. The TWS Bluetooth hearing aid according to claim 7, wherein a torsion spring is arranged on a middle part of the rotating rod, two ends of the torsion spring being respectively fixed to the buckle ring and the pressing plate, wherein the pressing plate is actable on by an external force to rotate outward so that the torsion spring acts on the buckle ring, wherein when the external force is removed, the torsion spring returns pushes the pressing plate to move towards the side wall of the housing.

9. The TWS Bluetooth hearing aid according to claim 1, wherein the charging connection mechanism includes a fixed column set on a bottom wall inside the inlet, a telescopic groove formed in a middle of a top end of the fixed column, and a spring provided on a bottom wall of the telescopic groove.

10. The TWS Bluetooth hearing aid according to claim 9, wherein a telescopic column is arranged partly inside the spring, and a baffle is arranged on an outer wall of a lower part of the telescopic column, and a lower part of the baffle is connected to the spring.

11. The TWS Bluetooth hearing aid according to claim 10, wherein an upper part of the telescopic column extends through an opening of the fixed column in communication with the telescopic groove and has a contact at a distal end contactable with an electrode piece on a bottom end of the earphone to achieve power transfer.

12. The TWS Bluetooth hearing aid according to claim 11, wherein a magnetic attraction piece is provided on a bottom wall of the connecting slot at one side thereof to attract a magnetic piece on a lower part of the earphone, such that the magnetic attraction piece and magnetic piece magnetically interact with each other to fix the earphone in the connecting slot.

13. The TWS Bluetooth hearing aid according to claim 12, wherein an adjustment plug is provided on a sound outlet of the earphone and is adapted to fit an ear canal of a user.

14. The TWS Bluetooth hearing aid according to claim 2, wherein the charging connection mechanism includes a fixed column set on a bottom wall inside the inlet, a telescopic groove formed in a middle of a top end of the fixed column, and a spring provided on a bottom wall of the telescopic groove.

15. The TWS Bluetooth hearing aid according to claim 14, wherein a telescopic column is arranged partly inside the spring, and a baffle is arranged on an outer wall of a lower part of the telescopic column, and a lower part of the baffle is connected to the spring.

16. The TWS Bluetooth hearing aid according to claim 15, wherein an upper part of the telescopic column extends through an opening of the fixed column in communication with the telescopic groove and has a contact at a distal end contactable with an electrode piece on a bottom end of the earphone to achieve power transfer.

17. The TWS Bluetooth hearing aid according to claim 16, wherein a magnetic attraction piece is provided on a bottom wall of the connecting slot at one side thereof to attract a magnetic piece on a lower part of the earphone, such that the magnetic attraction piece and magnetic piece magnetically interact with each other to fix the earphone in the connecting slot.

18. The TWS Bluetooth hearing aid according to claim 17, wherein an adjustment plug is provided on a sound outlet of the earphone and is adapted to fit an ear canal of a user.
